(19) United States
(12) Patent Application Publication
(10) Pub. No.: US 2012/0203402 A1
(43) Pub. Date: Aug. 9, 2012

(54) Intelligent Railway System for Preventing Accidents at Railway Passing Points and Damage to the Rail Track

(75) Inventors: Suyash S. Jape, Pune (IN); John G. Musial, Newburgh, NY (US); Abhinay R. Nagpal, Pune (IN); Sandeep R. Patil, Elmsford, NY (US)

(73) Assignee: International Business Machines Corporation, Armonk, NY (US)

(21) Appl. No.: 13/022,085

(22) Filed: Feb. 7, 2011

(51) Int. Cl. G05D 1/02; B61L 25/00

(52) U.S. Cl. 701/19

(57) ABSTRACT

An embodiment of the invention provides a method for controlling access to content in a social networking website, wherein a connection is established between a first user and a second user on the social networking website. Content on the profile pages of the first user is categorized into a first content category and a second content category. The first content category includes content created before the connection between the first user and the second user was established. The second content category includes content created after the connection between the first user and the second user was established. Content in the first content category is also categorized into a first subcategory and at least one second subcategory. Access by the second user is restricted to the first content category. Specifically, the second user is prevented from viewing content in the first subcategory and permitted to view content in the second subcategory.

### BACKGROUND

The present invention is in the field of methods, systems, and computer program products for an intelligent railway system for preventing accidents at railway passing points and reducing damage to the rail track.

Railway vehicles have bogies and wheel sets that impart lateral forces on the railway track. Typically, the forces have a component normal to the running rails, in the plane of the running rails. The expected and intended origin of these forces is to guide and steer the bogies and the vehicles along the railway track, thereby maintaining the vehicles on the track. The lateral forces are transmitted from the wheels to the track at the wheel-to-rail interface by the contact pressure of guiding flanges on the wheels to the running gage side of the rails. The lateral forces are also transmitted by the static and/or dynamic frictional interface of the wheel tread on the running surface of the rails. At times, rails tend to bend and develop cracks. At high railway speeds, these bends, cracks, or undulations are a cause of derailing and railway accidents

### SUMMARY OF THE INVENTION

An embodiment of the invention includes methods, systems, and computer program products for managing trains on a railway track. A system includes a plurality of track sensors positioned along the railway track to collect track measurement data. The track measurement data indicates physical loads exerted on the railway track at the track sensors. The system further includes a scheduling module connected to the track sensors. The scheduling module estimates, based on the track measurement data from the track sensors, a lower risk point of passing between a first train and a second train, the speed of the first train in order to arrive at the lower risk point of passing at the same time as the second train, and/or the speed of the second train in order to arrive at the lower risk point of passing at the same time as the first train. The first train is traveling in a first direction along the railway track, and the second train traveling in a second direction along the railway track opposite the first direction.

Another embodiment of the invention analyzes ground conditions data from a plurality of ground sensors positioned along the railway track. Based on the analysis of the ground conditions data, a lower risk point of passing between a first train and a second train, the speed of the first train in order to arrive at the lower risk point of passing at the same time as the second train, and/or the speed of the second train in order to arrive at the lower risk point of passing at the same time as the first train is estimated.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 is a flow diagram illustrating a method to prevent accidents and rail track damages according to an embodiment of the invention;

FIG. 2 illustrates a system for managing trains on a railway track according to an embodiment of the invention;

FIG. 3 is a flow diagram illustrating a method for managing trains on a railway track according to an embodiment of the invention;

FIG. 4 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

An embodiment of the invention provides methods and systems for smart rail travel, wherein the passing point and speeds of two trains traveling in opposite directions on parallel rail tracks are adjusted in order to prevent accidents through bending, cracking or buckling of the rail tracks. In addition, the underlying ground conditions of the track are detected and the safest point in a localized area where two trains can pass is selected.

When two trains pass each other, the forces between their rails are extremely high. Since trains have fixed schedules, they pass each other at the same points on a daily basis. At such points, bends and/or cracks tend to form on the rails. An embodiment of the invention utilizes sensors on the rails to identify areas where the rails are weak. Thus, the best point for the trains to pass is determined and the speeds of both trains are adjusted so that the trains pass at the safest point. At least one embodiment of the invention balances the load on the rails by changing the passing point, for example, on a daily basis. Thus, in the example, the point of passing (i.e., the area on the track where a high force is exerted by the passing trains) is different from the point of passing on the previous day.

Another embodiment of the invention provides appropriate travel speeds based on the underlying ground conditions. Based on the sensor feedback, the speed of the train is adjusted. For example, in water logged or soft ground areas, the train is made to travel at slow speed; and, in hard ground or newly built areas of the track, the train travels at a higher speed. Furthermore, the best passing point for two trains is calculated based on underlying ground conditions. At least one embodiment of the invention integrates with geographic information systems and geospatial analysis. This intelligently uses dynamic information obtained from sensors and makes decisions to improve rail travel safety.

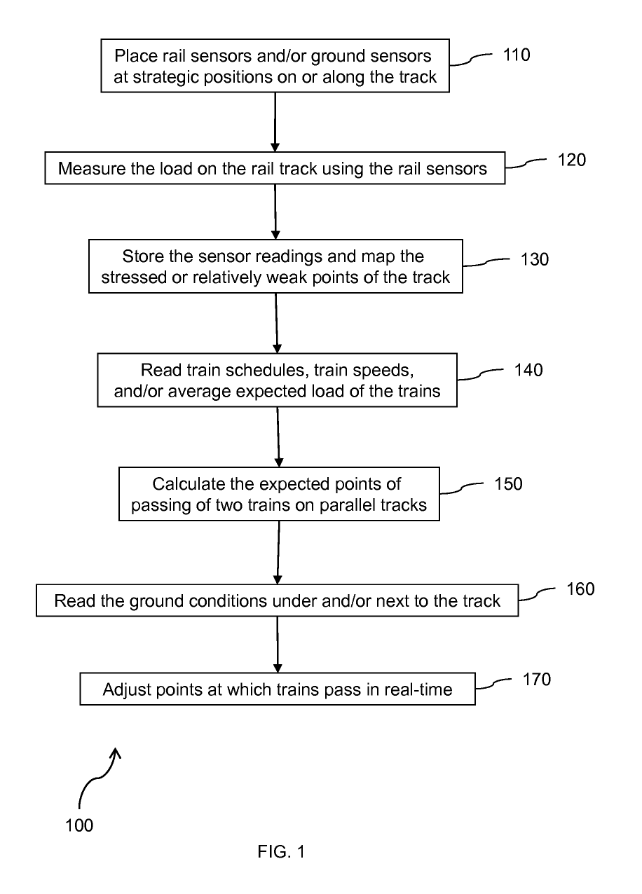

FIG. 1 is a flow diagram illustrating a method 100 to prevent accidents and rail track damage according to an embodiment of the invention. Rail sensors (also referred to herein as “track sensors”) and/or ground sensors are placed at strategic positions on or along the rail track 110. As used herein, “railway” or “railway track” refers to one or two pairs of corresponding rails, wherein each pair of rails provides a route, line, or path for travel by a train, railcar, or other railway vehicle (typically in a single direction). Each pair of rails is referred to as a “track” or “rail track”. In at least one embodiment, the intervals between the sensor positions are chosen to be approximately representative of the rail and ground conditions of where the sensor is placed.

The rail sensors measure the load on the rail track at that position 120. Thus, data is obtained that is indicative of the loads that a rail vehicle wheel exerts on the railway as the vehicle rolls past the sensor. In at least one embodiment, the data is also processed to extract information indicative of the health of the rolling mechanisms associated with the vehicle. The sensors are connected to a computer system which stores the sensor readings and maps the stressed or relatively weak points of the track 130.

The computer system examines train schedules, the speeds that the trains travel in particular sections, and/or the average expected load of the trains 140. Based on this data, the computer system calculates the expected points of passing of two trains on parallel tracks 150. In order to identify higher and/or lower risk points of passing, the computer system also analyzes (either from the sensors or other source), in at least one embodiment, average train speed, average train load, average variations in vertical alignment of tracks within a number of degrees tolerance of the exiting grade, current train load, current train speed, current weather conditions, current ground conditions including moisture content, and/or current variations in vertical alignment of tracks within a number of degrees tolerance of the exiting grade. As described more fully below, proper vertical alignment maintains the appropriate equilibrium and avoids derailment.

At least one embodiment of the invention also utilizes ground sensors to read the ground conditions (e.g., ground hardness/density, dampness, water logging) under and/or next to the railway track 160. In another embodiment, sensors are utilized that measure the load on the rail track as well as ground conditions. In at least one embodiment, the computer system also analyzes data such as railway proximity to bodies of water (e.g., rivers, lakes, and streams). In another embodiment, the track and ground conditions are mapped using geographic information systems and geospatial analysis. Each position of interest is tracked with 3-dimensional geo-coordinates. These coordinates are used by the computer system for fault analysis.

Data regarding the track and ground conditions is continuously collected and analyzed. Based on the above historical and/or real-time factors, points at which railway cars pass each other at high speeds in opposite directions can be adjusted in real-time by the computer system in order to provide the least amount of stress on the rails and the safest possible conditions for rail travel at that particular point in time 170. Specifically, adjusting the pass point between two trains involves adjusting the speeds of the trains and/or the timing and/or duration of stop signals along the railway track.

In at least one embodiment, the pass point between two trains is adjusted with minimal impact to the train schedule. More specifically, the computer system identifies the next stations where either or both trains are scheduled to arrive and calculates estimated arrival times based on the adjusted pass point. The estimated arrival times are compared to the scheduled arrival times. If the difference between the estimated arrival times and the scheduled arrival times is above a threshold level, then another adjusted pass point is calculated. In another embodiment, the computer system calculates multiple potential pass points, calculates their respective impact on the scheduled arrival times, and allows a user to select one of the potential pass points. In yet another embodiment, the computer system automatically selects one of the potential pass points based on user-defined rules, e.g., neither train A nor train B delayed for >10 minutes; combined delay of train A and train B<30 minutes.

In at least one embodiment of the invention, trains in a select area are tracked using GPS or local sensors on the track to identify which train(s) passed by a checkpoint. An embodiment of the invention includes a scheduling system that is triggered when two trains arrive at a certain threshold distance from one another, wherein:
D=Distance between the two trains
SA=Speed of Train A
SB=Speed of Train B
PA=Passing Area (i.e., area of track where Train A and Train B will potentially pass each other with their current speed)
   As the trains approach each other, the relative velocity of the trains=(Sa+Sb). Thus, the time until the trains meet is represented as Tm, where Tm=D/(Sa+Sb). The distance traveled by Train A is represented as Da, where Da=D(Sa/(Sa+Sb)).

The geospatial coordinates of the trains are known at the time of calculation. Adding distance Da to the position of Train A, the scheduling system obtains the coordinates where the two trains will pass, represented as position M. The Passing Area (PA) is calculated as distance on either side of M, corresponding to the length of each train on either side.

PA=La<−M−>Lb

PA is a function which determines whether the passing area is safe using the following formula:

{CAx II CAy II CAz}

where TRUE indicates a safe area to pass.
CAx=marked tracked area of contention via historical and site visit data collection and can have values of either 1 or 0 (1=bad track, 0=good track)
CAy=condition of track (obtained via age of the tracks and via sensors which help detect dynamic health of the track and can have values of either 1 or 0 (1=bad condition, 0=good condition)
CAz=current condition of the underlying soil (using sensors that will help detect the dynamic strength of the soil and measure the moisture in soil and water logged conditions) and can have values of either 1 or 0 (1=bad condition, 0=good condition)

At least one embodiment of the invention utilizes sensors (rail sensors, ground sensors, or combination rail and ground sensors) to measure the vertical alignment of the rails within a number of degrees tolerance of the exiting grade. Such sensors are connected to a central computer system to store the sensor readings and identify the sections of track that are outside the tolerances of vertical alignment. Alignment is defined in two fashions. First, the horizontal alignment defines physically where the route or track goes (mathematically the X-Y plane). The second component is a vertical alignment, which defines the elevation, rise, and fall (the Z component).

Sensor readings are taken while the tracks are under the load of a train during travel and/or when they are not under load of a train. Measuring the vertical alignment of tracks within a number of degrees tolerance of the exiting grade while the tracks are under the load of a train during travel is especially interesting when the underlying support is a bridge structure. An increase over time in the amount of flex under load would indicate stress or weakening of the underlying support system. Additionally, measuring the vertical alignment of tracks within a number of degrees tolerance of the exiting grade while the tracks are not currently under load can also alert individuals and/or systems monitoring the measurement data to any intentional disruption, alteration, or disturbances to the rails, such as vandalism, sabotage or terrorism.

At least one embodiment of the invention measures track vibrations when it is known that a section of track is not currently being used by a train or undergoing maintenance. This would also alert individuals and/or systems monitoring the measurement data to any intentional tampering (e.g., a hammer striking the track while vandals are stealing spikes) or unintentional disruption (e.g., a tree falls on the tracks or a car accident where the car goes off the road and lands on or strikes train tracks).

In selecting a low risk point of passing for two trains, at least one embodiment of the invention also analyzes the history of repair work on sections of track. If a section of track has undergone and/or is scheduled to undergo repairs and/or non-routine maintenance, then (excluding other factors) that section of track is identified as a higher risk point of passing relative to other sections of track that have not undergone and/or are not scheduled for repairs. Moreover, a section of track that has recently undergone routine maintenance is identified as a lower risk point of passing (excluding other factors).

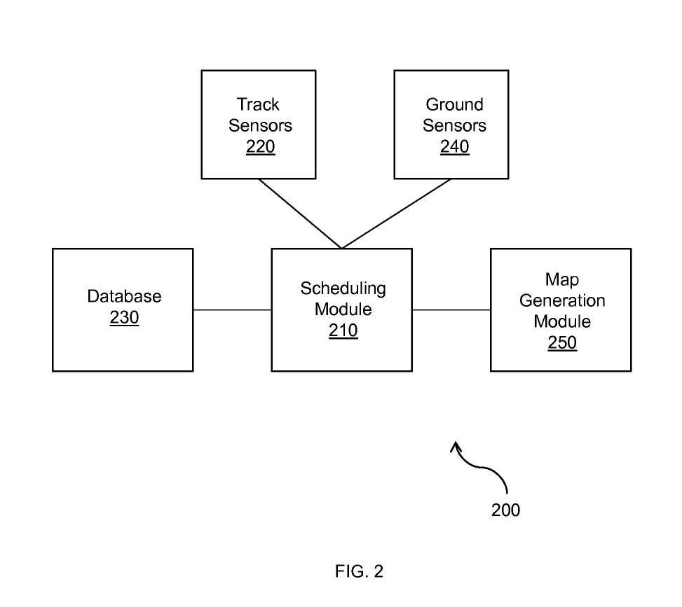

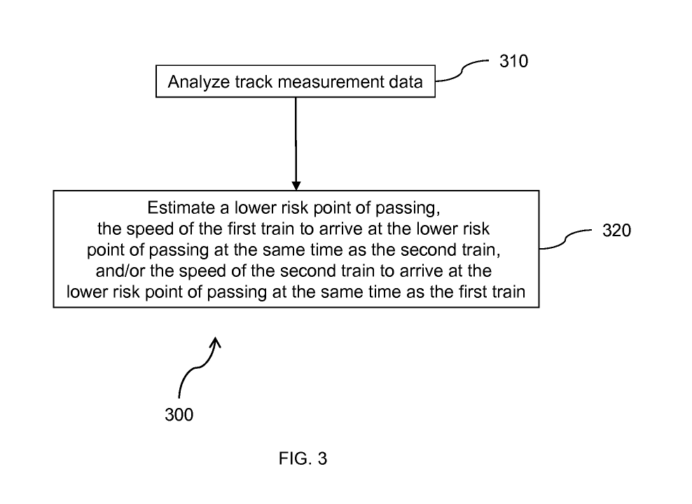

FIG. 2 illustrates a system 200 for managing trains on a railway track according to an embodiment of the invention. As used herein, the term “railway track” refers to 2 pairs of corresponding rails, wherein each pair of rails provides a route, line, or path for travel by a train, railcar, or other railway vehicle, e.g., 2 pairs of adjacent rails, the first pair for traveling in a west to east direction, the second pair for traveling in an east to west direction. FIG. 3 is a flow diagram illustrating a method 300 for managing trains on a railway track according to an embodiment of the invention, for example, using the system 200.

The system 200 includes a computer program processor 210 (also referred to herein as a “scheduling module”) connected to a plurality of track sensors 220. The track sensors 220 identify at least one area of potential track weakness. More specifically, the track sensors 220 are positioned along the railway track to collect track measurement data, wherein the track measurement data indicates physical loads exerted on the railway track at the track sensors 220.

Track measurement data from the track sensors 220 is analyzed (310). Based on this analysis, the computer program processor 210 estimates at least one lower risk point of passing between a first train and at least one second train, at least one speed of the first train to arrive at the lower risk point of passing at the same time as the second train, and/or at least one speed of the second train to arrive at the lower risk point of passing at the same time as the first train (320). The first train is traveling in a first direction along the railway track; and, the second train is traveling in a second direction along the railway track opposite the first direction. The speed of the first train and/or speed of the second train as used herein refers to average speed, speeds for specific time intervals (e.g., 50 mph for first 10 minutes; 80 mph for following 30 minutes), and/or speeds for specific distances/areas (e.g., 25 mph for first 8 miles; 25 mph within city limits). As used herein, lower risk point of passing refers to a point or area where the risk of accident and/or damage to the railway is lower relative to other potential points of passing between the trains (including a calculated point of passing if the trains were to continue at their current speeds).

The system 200 further includes an electronic database 230 connected to the track sensors 220. The electronic database 230 includes historical track measurement data from the track sensors 220. In at least one embodiment, the historical track measurement data in the database and/or real-time track measurement data from the track sensors 220 are analyzed by the computer program processor 210.

In addition, in at least one embodiment of the invention, the computer program processor 210's estimate of the lower risk point of passing, the speed of the first train, and/or second speed of the second train is further based on horizontal rail alignment data and/or vertical rail alignment data. The horizontal rail alignment data identifies at least one curved area of the railway track and/or at least one straight area of the railway track. The vertical rail alignment data identifies at least one banked (i.e., tilted) area of the railway track and/or at least one flat area of the railway track. In at least one embodiment of the invention, the computer program processor 210 predicts that, excluding other factors, the risk of accident and/or damage to the railway is lower where the railway track is flat and/or straight. Similarly, excluding other factors, the computer program processor 210 predicts that the risk of accident and/or damage to the railway is higher where the railway track is banked and/or curved.

In addition, at least one embodiment of the invention analyzes ground conditions data along the railway track. More specifically, the system 200 includes ground sensors 240 connected to the computer program processor 210, wherein the ground sensors 240 collect the ground conditions data. In one embodiment, the ground sensors 240 are housed in the track sensors 220 to form combination ground and track sensors.

The scheduling module 210 further analyzes the ground conditions data to estimate the lower risk point of passing, the speed of the first train, and/or second speed of the second train. The ground conditions data includes ground moisture, air moisture, current weather conditions (e.g., temperature, precipitation, humidity, wind), and a weather forecast. Excluding other factors, the computer program processor 210 predicts that the risk of accident and/or damage to the railway is lower in drier areas. Similarly, excluding other factors, the computer program processor 210 predicts that the risk of accident and/or damage to the railway is higher in wetter areas and/or areas of high wind and/or extreme temperatures.

In at least one embodiment of the invention, the lower risk point of passing, the speed of the first train, and/or second speed of the second train is estimated based solely on the ground conditions data. In another embodiment, the electronic database 230 includes historical track measurement data and/or historical ground conditions data.

Furthermore, in at least one embodiment of the invention, the computer program processor 210 includes a map generation module 250. The map generation module 250 generates one or more maps showing at least one higher risk point of passing and/or at least one lower risk point of passing. The map(s) are generated based on the track measurement data, the ground conditions data, the horizontal rail alignment data, and/or vertical rail alignment data.

At least one embodiment of the invention identifies when the first train is a threshold distance from the second train. The estimating of the lower risk point of passing, the speed of the first train, and/or the speed of the second train is triggered when the first train is the threshold distance from the second train. In at least one embodiment, the estimating includes calculating a predicted passing point between the first train and the second train based on the current speed of the first train and the current speed of the second train. It is determined whether the predicted passing point meets a threshold level of safety based on the track measurement data, the ground conditions data, the horizontal rail alignment data, and/or the vertical rail alignment data. If the threshold level of safety is not met, the lower risk point of passing is estimated. If the threshold level of safety is met, then the scheduling of the trains (i.e., passing point, speeds) is not altered.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute with the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

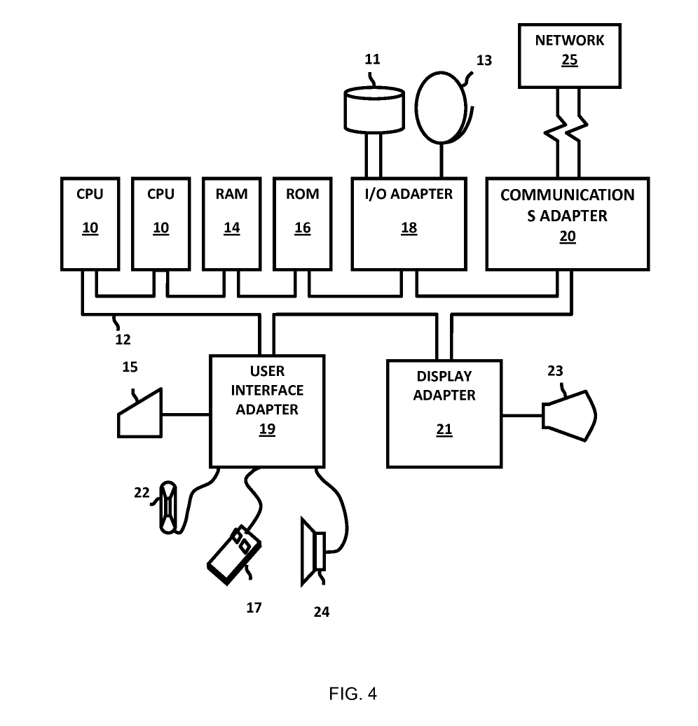

Referring now to FIG. 4, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for managing trains on a railway track, said method including:
analyzing track measurement data from a plurality of track sensors positioned along the railway track to collect the track measurement data, the track measurement data indicating physical loads exerted on the railway track at the track sensors; and
estimating, based on said analyzing of the track measurement data from the plurality of track sensors, at least one of:
at least one lower risk point of passing between a first train and at least one second train, the first train traveling in a first direction along the railway track, and the second train traveling in a second direction along the railway track opposite the first direction,
at least one speed of the first train to arrive at the lower risk point of passing at the same time as the second train, and
at least one speed of the second train to arrive at the lower risk point of passing at the same time as the first train.

2. The method according to claim 1, further including maintaining a database of historical track measurement data from the plurality of track sensors,
wherein said analyzing of the track measurement data includes analyzing at least one of the historical track measurement data in the database and real-time track measurement data from the plurality of track sensors.

3. The method according to claim 1, wherein said estimating of at least one of the lower risk point of passing, the speed of the first train, and the speed of the second train is further based on at least one of
horizontal rail alignment data and vertical rail alignment data,
the horizontal rail alignment data identifying at least one of a curved area of the railway track and a straight area of the railway track, and
the vertical rail alignment data identifying at least one of a banked area of the railway track and a flat area of the railway track.

4. The method according to claim 1, further including analyzing ground conditions data along the railway track, wherein said estimating of at least one of the lower risk point of passing, the speed of the first train, and the speed of the second train is further based on said analyzing of the ground conditions data.

5. The method according to claim 4, wherein the ground conditions data is collected from at least one of a plurality of ground sensors positioned along the railway track and the plurality of track sensors.

6. The method according to claim 4, wherein the ground conditions data includes at least one of ground moisture, air moisture, current weather conditions, and a weather forecast.

7. The method according to claim 1, further including generating a map based on at least one of the track measurement data, ground conditions data, horizontal rail alignment data, and vertical rail alignment data, the map including at least one higher risk point of passing.

8. The method according to claim 1, further including identifying when the first train is a threshold distance from the second train, wherein said estimating of at least one of the lower risk point of passing, the speed of the first train, and the speed of the second train is triggered when the first train is the threshold distance from the second train.

9. The method according to claim 1, wherein said estimating of at least one of the lower risk point of passing, the speed of the first train, and the speed of the second train includes:
calculating a predicted passing point between the first train and the second train based on a current speed of the first train and a current speed of the second train;
determining whether the predicted passing point meets a threshold level of safety based on at least one of analyzing of ground conditions data, analyzing of horizontal rail alignment data, analyzing of vertical rail alignment data, and said analyzing of the track measurement data; and
estimating the lower risk point of passing if the threshold level of safety is not met.

10. A method for managing trains on a railway track, said method including:
analyzing ground conditions data from a plurality of ground sensors positioned along the railway track; and
estimating, based on said analyzing of the ground conditions data from the plurality of ground sensors, at least one of:
at least one lower risk point of passing between a first train and at least one second train, the first train traveling in a first direction along the railway track, and the second train traveling in a second direction along the railway track opposite the first direction,
at least one speed of the first train to arrive at the lower risk point of passing at the same time as the second train, and
at least one speed of the second train to arrive at the lower risk point of passing at the same time as the first train.

11. The method according to claim 10, wherein the ground conditions data includes at least one of ground moisture, air moisture, current weather conditions, and a weather forecast.

12. The method according to claim 10, further including maintaining a database of historical ground conditions data from the plurality of ground sensors, wherein said analyzing of the ground conditions data includes analyzing at least one of the historical ground conditions data in the database and real-time ground conditions data from the plurality of ground sensors.

13. The method according to claim 10, wherein said estimating of at least one of the lower risk point of passing, the speed of the first train, and the speed of the second train is further based on at least one of horizontal rail alignment data and vertical rail alignment data,
the horizontal rail alignment data identifying at least one of a curved area of the railway track and a straight area of the railway track, and the vertical rail alignment data identifying at least one of a banked area of the railway track and a flat area of the railway track.

14. The method according to claim 10, further including analyzing track measurement data from a plurality of track sensors positioned along the railway track, the track measurement data indicating physical loads exerted on the railway track at the track sensors.

15. The method according to claim 10, further including generating a map based on at least one of the ground conditions data, track measurement data, horizontal rail alignment data, and vertical rail alignment data, the map including at least one higher risk point of passing.

16. The method according to claim 10, further including identifying when the first train is a threshold distance from the second train, wherein said estimating of at least one of the lower risk point of passing, the speed of the first train, and the speed of the second train is triggered when the first train is the threshold distance from the second train.

17. The method according to claim 10, wherein said estimating of at least one of the lower risk point of passing, the speed of the first train, and the speed of the second train includes:
calculating a predicted passing point between the first train and the second train based on a current speed of the first train and a current speed of the second train;
determining whether the predicted passing point meets a threshold level of safety based on at least one of analyzing of ground conditions data, analyzing of horizontal rail alignment data, analyzing of vertical rail alignment data, and said analyzing of the ground conditions data; and
estimating the lower risk point of passing if the threshold level of safety is not met.

18. A system for managing trains on a railway track, said system including:
a plurality of track sensors positioned along the railway track to collect track measurement data, the track measurement data indicating physical loads exerted on the railway track at the track sensors;
a scheduling module connected to said track sensors, said scheduling module estimates, based on the track measurement data from said track sensors, at least one of:
at least one lower risk point of passing between a first train and at least one second train, the first train traveling in a first direction along the railway track, and the second train traveling in a second direction along the railway track opposite the first direction,
at least one speed of the first train to arrive at the lower risk point of passing at the same time as the second train, and
at least one speed of the second train to arrive at the lower risk point of passing at the same time as the first train.

19. The system according to claim 18, further including an electronic database connected to said track sensors, said electronic database including historical track measurement data from the plurality of track sensors,
wherein said scheduling module analyzes at least one of the historical track measurement data in said electronic database and real-time track measurement data from said track sensors to estimate at least one of the lower risk point of passing, the speed of the first train, and the speed of the second train.

20. The system according to claim 18, wherein said scheduling module further analyzes at least one of horizontal rail alignment data and vertical rail alignment data to estimate of at least one of the lower risk point of passing, the speed of the first train, and the speed of the second train,
wherein the horizontal rail alignment data identifying at least one of a curved area of the railway track and a straight area of the railway track, and the vertical rail alignment data identifying at least one of a banked area of the railway track and a flat area of the railway track.

21. The system according to claim 18, further including ground sensors connected to said scheduling module, said ground sensors collect ground conditions data, the ground conditions data including at least one of ground moisture, air moisture, current weather conditions, and a weather forecast.

22. The system according to claim 21, wherein said ground sensors are housed in said track sensors.

23. The system according to claim 21, wherein said scheduling module further analyzes the ground conditions data to estimate at least one of the lower risk point of passing, the speed of the first train, and the speed of the second train.

24. The system according to claim 18, further including a map generation module in said scheduling module, said map generation module generates a map based on at least one of the track measurement data, ground conditions data, horizontal rail alignment data, and vertical rail alignment data, the map including at least one higher risk point of passing.

25. A computer program product for managing trains on a railway track, said computer program product including:
a computer readable storage medium;
first program instructions for analyzing track measurement data from a plurality of track sensors positioned along the railway track to collect the track measurement data, the track measurement data indicating physical loads exerted on the railway track at the track sensors; and
second program instructions for estimating, based on said analyzing of the track measurement data from the plurality of track sensors, at least one of:
at least one lower risk point of passing between a first train and at least one second train, the first train traveling in a first direction along the railway track, and the second train traveling in a second direction along the railway track opposite the first direction,
at least one speed of the first train to arrive at the lower risk point of passing at the same time as the second train, and
at least one speed of the second train to arrive at the lower risk point of passing at the same time as the first train,
said first program instructions and said second program instructions are stored on said computer readable storage medium.
